(19) United States
(12) Patent Application Publication
(10) Pub. No.: US 2022/0120031 A1
(43) Pub. Date: Apr. 21, 2022

(54) METHOD OF STRENGTHENING NON-KERATINOUS FIBERS, AND USES THEREOF

(71) Applicant: ISP INVESTMENTS LLC, Wilmington, DE (US)

(72) Inventors: Ramune Van MOORSEL-MUREIKAITE, Ridderkerk (NL); Diem Thi Truc TRAN, Hendrik-ldo-Ambacht (NL); Gijsbert KROON, Giessenburg (NL)

(73) Assignee: ISP INVESTMENTS LLC, Wilmington, DE (US)

(21) Appl. No.: 17/423,799

(22) PCT Filed: Jan. 15, 2020
(86) PCT No.: PCT/US20/13732

§ 371 Date: Jul. 16, 2021

Related U.S. Application Data
(60) Provisional application No. 62/793,699, filed on Jan. 17, 2019.

(51) Int. Cl. D06M 13/402

(52) U.S. Cl. CPC D06M 13/402; D06M 2101/06

(57) ABSTRACT

Disclosed is a method of treating non-keratinous fibers using a composition comprising an amide and/or alkyl ammonium carboxylate salt wherein the treating method improves the robust performance of the non-keratinous fibers and simultaneously maintains and/or improve the appearance or look such as color, shine, form, and shape of the fibers even after prolonged use. The method of protecting colored non-keratinous fibers from fading using the composition comprising an amide and/or alkyl ammonium carboxylate salt is also disclosed.

### FIELD OF THE PRESENT DISCLOSURE

The presently disclosed and/or claimed inventive process(es), procedure(s), method(s), product(s), result(s), and/or concept(s) (collectively hereinafter referred to as the “present disclosure”) relates generally to a method of treating non-keratinous fibers using a composition comprising an amide and/or alkyl ammonium carboxylate salt.

### BACKGROUND OF THE PRESENT DISCLOSURE

Despite enormous variety of textile materials existing in the market, there exists a continuous demand for new textile materials having desired performance attributes based on their intended end use applications. The fabric or apparel industry is one of those applications wherein the textile materials are desired primarily for addressing emerging fashion trends. However, consumers also want their fabrics to last longer and maintain the original shapes and appearances. The desirability for textile materials is often impacted by a number of factors, for Example, by appearance such as color, pattern, and sheen; by wearing qualities such as crease resistance, water resistance, and stain resistance; by feel; by texture; or by care requirements such as easy wash, quicker drying time, color fast, and less shrinkage. These and other desirable performance attributes are typically achieved by treating the textile materials with finishing products.

The selection of finishing products thus depends on the performance attributes desired in the textile materials. For ex

ample, treating textile materials, particularly cotton fabrics, with crosslinking agents (also referred to as resins or crosslinkers) to improve their “wrinkle resistant” properties is well known. Over the years, several crosslinking agents have been developed, for example, isocyanates, epoxides, divinylsulfones, aldehydes, chlorohydrins, N-methylol compounds, and polycarboxylic acids. The use of these crosslinking agents improves other properties as well such as smoothness, dimensional stability, pilling resistance, ease of ironing, durability and general appearance.

Similarly, textile materials based on synthetic fibers and/or blends of cotton and synthetic fibers are treated with finishing products to achieve desirable performance attributes. However, these finishing products cause certain undesirable side-effects, for example, loss in tear and tensile strength, loss in abrasion resistance, reduced moisture regain, possible damage due to chlorine retention, potential odors, potential discoloration, and sewing problems.

Therefore, there has been a long need for a composition(s) that can provide non-keratinous fibers, textile materials and/or other textile articles derived therefrom with improved robust performance, and wherein the non-keratinous fibers, textile materials and/or other textile articles derived therefrom can maintain the color, form, shape, and also maintain and/or improve the natural feel even after prolonged use.

The present inventors have surprisingly found that the composition comprising an amide and/or an alkyl ammonium carboxylate salt can be used for treating non-keratinous fibers, textile materials and/or other textile articles derived therefrom to provide desirable performance attributes.

### SUMMARY OF THE PRESENT DISCLOSURE

One aspect of the present disclosure provides a method of treating non-keratinous fibers with a composition represented by one or both of the following formulas:

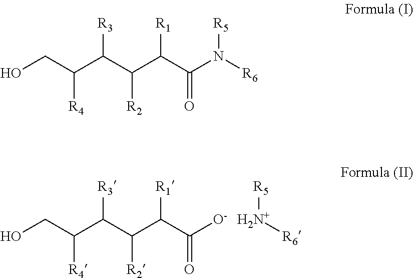

wherein R₁-R₄ are independently hydrogen, a hydrocarbon radical having 1 to about 10 carbon atoms, a hydroxyl group, an amino group, a sulfhydryl group, an aryl group, or a halogen; R₅ and R₆ are independently hydrogen, an aliphatic hydrocarbon group, an alicyclic hydrocarbon group, an aryl group, an alkylaryl group or a heterocyclic group; wherein R₁′-R₄′ are independently hydrogen, a hydrocarbon radical having 1 to about 10 carbon atoms, a hydroxyl group, an amino group, a sulfhydryl group, an aryl group, or a halogen; R₅′ and R₆′ are independently hydrogen, an aliphatic hydrocarbon group, an alicyclic hydrocarbon group, an aryl group, or a heterocyclic group, excluding R₅′ and R₆′ being simultaneous hydrogens; wherein the aliphatic hydrocarbon group, the alicyclic hydrocarbon group, the aryl group, the alkylaryl group or the heterocyclic group is substituted with at least one hydroxyl group.

Another aspect of the present disclosure provides a method of treating non-keratinous fibers with a composition represented by the chemical formulations selected from the group consisting of Formula (III), Formula (IV), Formula (V), and combinations thereof:

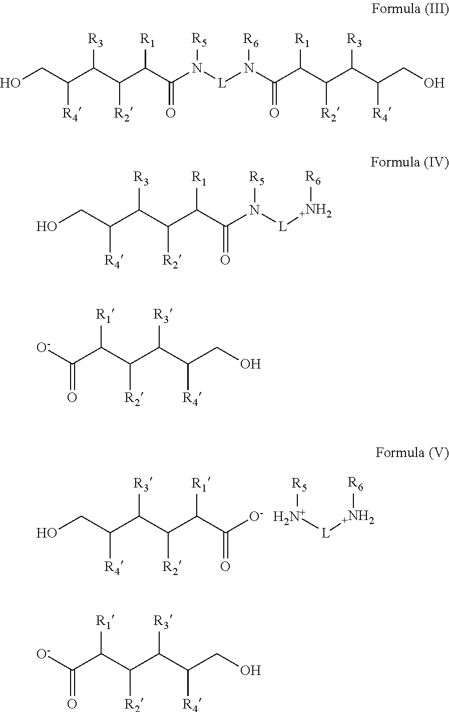

wherein R₁′-R₄′ are independently hydrogen, a hydrocarbon radical having 1 to about 10 carbon atoms, a hydroxyl group, an amino group, a sulfhydryl group, an aryl group, or a halogen; R₅′-R₆′ are independently hydrogen, an aliphatic hydrocarbon group, an alicyclic hydrocarbon group, an aryl group, an alkylaryl group, or a heterocyclic group; and L is a linking group and is an aliphatic hydrocarbon group, an alicyclic hydrocarbon group, an aryl group, an alkylaryl group, or a heterocyclic group.

Still another aspect of the present disclosure provides a use of a composition represented by one or both of the following formulas for treating non-keratinous fibers, textile materials and/or other textile articles derived therefrom:

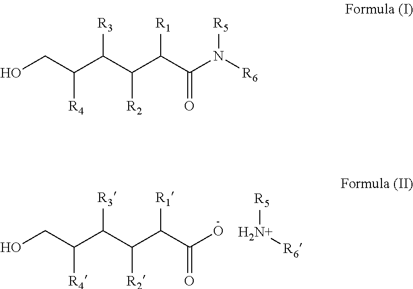

wherein R₁-R₄, R₅ and R₆, R₁′-R₄′; R₅′-R₆′ are as described above.

Yet another aspect of the present disclosure provides a use of a composition represented by chemical formulations selected from the group consisting of Formula (III), Formula (IV), Formula (V), and combinations thereof for treating non-keratinous fibers, and/or textile materials and/or other textile articles derived therefrom:

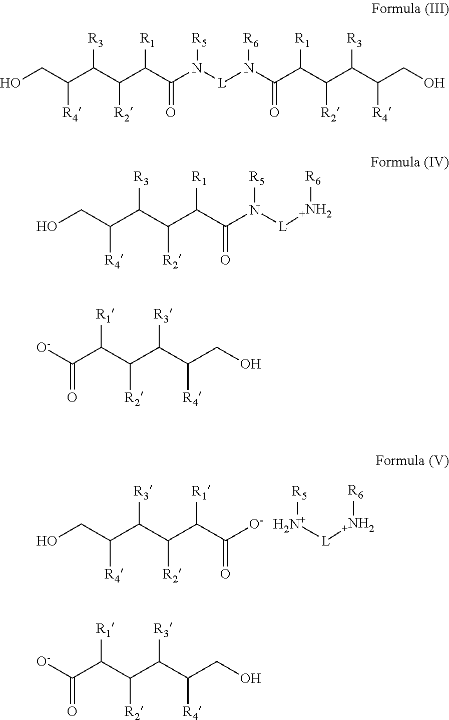

wherein R₁′-R₄′ is as described above and L is a linker and is an aliphatic hydrocarbon group, an alicyclic hydrocarbon group, an aryl group, an alkylaryl group, or a heterocyclic group.

### BRIEF DESCRIPTION OF THE FIGURES

Objects, features, and advantages of the present invention will become apparent upon reading the following description in conjunction with the drawings/figures, in which:

FIG. 1 shows “Tear Strengths” of (i) polyester and cotton swatches treated with 1 wt. % and 5 wt. % aqueous solutions of the End Product of Example 4, (ii) untreated polyester and cotton swatches, and (iii) polyester and cotton swatches treated with 1 wt. % aqueous solution of citric acid.

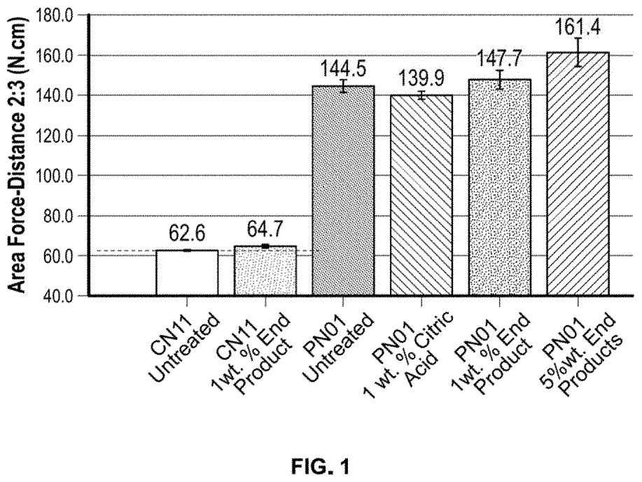

FIG. 2 shows “survival probabilities versus cycle number” of the cotton swatches treated with 1 wt. % aqueous solution of the End Product of Example 4, and (ii) untreated (control) cotton swatch.

FIG. 3 shows “Graph representing tests done on single wool wash & rinse cycle for Total tear strength”.

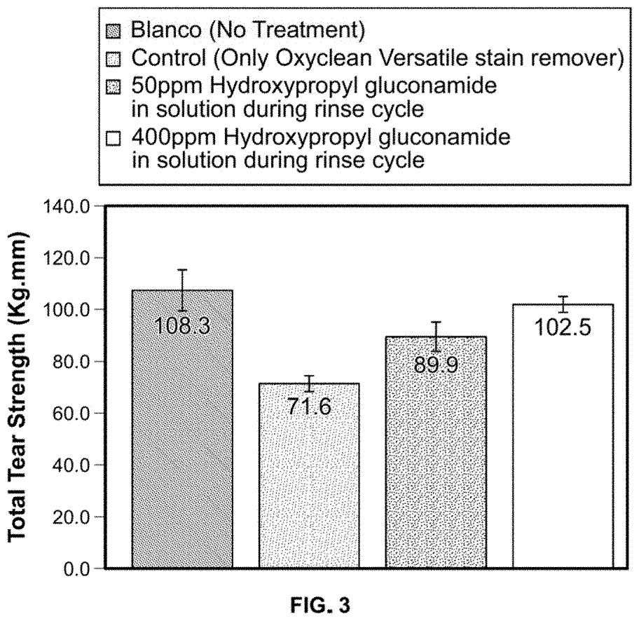

FIG. 4 shows “Graph representing tests done on polyester with five wash & rinse cycles for Total tear strength”.

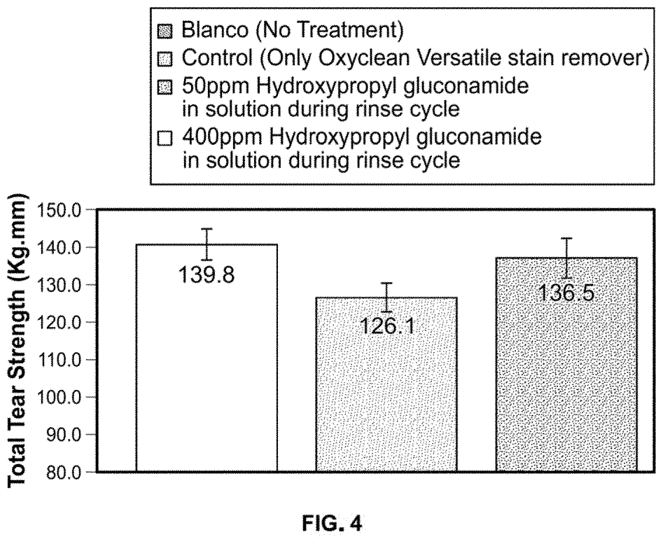

### DETAILED DESCRIPTION OF THE PRESENT DISCLOSURE

Before explaining at least one embodiment of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions and/or methods disclosed herein can be made and executed without undue experimentation in light of the present disclosure. While the compositions and methods of the present disclosure have been described in terms of preferred embodiments, it will be apparent to those of ordinary skill in the art that variations may be applied to the compositions and/or methods and in the steps or in the sequence of steps of the method described herein without departing from the concept, spirit and scope of the present disclosure. All such similar substitutes and modifications apparent to those skilled in the art are deemed to be within the spirit, scope and concept of the present disclosure.

As utilized in accordance with the present disclosure, the following terms, unless otherwise indicated, shall be understood to have the following meanings.

The use of the word “a” or “an” when used in conjunction with the term “comprising” may mean “one,” but it is also consistent with the meaning of “one or more, at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein the term “non-keratinous fibers” refers to fibrous structures devoid of keratin (a fibrous protein forming the main structural constituent of hair, feathers, hoofs, claws, horns, and the like). These fibrous structures can be staple length fibers or continuous fibers, and can be natural fibers such as cotton, silk, and mixtures thereof, or synthetic fibers such as polyacrylonitrile, nylon, polyamide, and polyesters, triacetate, polyethylene, propylene, and mixtures thereof, or any combinations of the natural and synthetic fibers.

As used herein the term “textile material” refers to a cloth or fabric made from the non-keratinous fibers of the present disclosure.

As used herein the term “textile article” refers to an article made from the textile materials of the present disclosure. Such articles can include, but are not limited to, clothings, towels and other bath linens, bed linens, table cloths, carpets, curtains, upholstery coverings, sleeping bags, tents, shoes, and car interior (such as car seat covers, car floor mats).

As used herein the term, “adjunct materials” means a material or a combination of materials that can be used along with the composition of the present disclosure to deliver one or more of the following benefits to the non-keratinous fibers, and/or textile materials and/or other textile articles derived therefrom that include, but are not limited to, fabric softening, fabric lubrication, fabric relaxation, durable press, wrinkle resistance, wrinkle reduction, ease of ironing, abrasion resistance, fabric smoothing, anti-felting, anti-pilling, crispness, appearance enhancement, appearance rejuvenation, color protection, color rejuvenation, anti-shrinkage, in-wear shape retention, fabric elasticity, fabric tensile strength, fabric tear strength, static reduction, water absorbency or repellency, stain repellency, refreshing, anti-microbial, odor resistance, and any combinations thereof. The adjunct materials can be selected from pH adjusters, surfactants, emulsifiers, detergents, builders, rheology modifiers, thickening agents, antioxidants, radical scavengers, chelants, antifoaming agents, conditioning agents, antistatic agent, antimicrobials or preservatives, dyes or colorants, viscosity control agents, pearlizing and opacifying agents, chlorine scavengers, brighteners, perfumes, and mixtures thereof.

The present disclosure relates to a method of treating non-keratinous fibers with a composition comprising an amide and/or an alkyl ammonium carboxylate salt. The amide can be a monoamide and/or a bisamide. The treatment of non-keratinous fibers with the composition of present disclosure improves the robust performance of the non-keratinous fibers. Examples of robust performance include, but are not limited to, tensile strength, tear strength, abrasion resistance, and pilling resistance. Further, the composition of present disclosure also maintains and/or improves the appearance or look such as color, shine, form, and shape, and natural feel of the non-keratinous fibers even after prolonged use.

In one non-limiting embodiment, the composition for treating the non-keratinous fibers can be represented by Formula (I) or Formula (II), or Formula (I) and Formula (II):

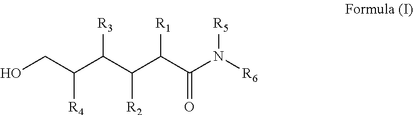

wherein R₁-R₄ are independently hydrogen, a hydrocarbon radical having 1 to about 10 carbon atoms, a hydroxyl group, an amino group, a sulfhydryl group, an aryl group, or a halogen; R₅ and R₆ are independently hydrogen, an aliphatic hydrocarbon group, an alicyclic hydrocarbon group, an aryl group, an alkylaryl group or a heterocyclic group. The aliphatic hydrocarbon group, the alicyclic hydrocarbon group, the aryl group, the alkylaryl group, or the heterocyclic group can be substituted with at least one hydroxyl group;

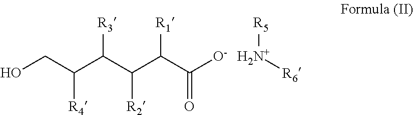

wherein R₁′-R₄′ are independently hydrogen, a hydrocarbon radical having 1 to about 10 carbon atoms, a hydroxyl group, an amino group, a sulfhydryl group, an aryl group, an alkyaryl group or a halogen; R₅′ and R₆′ are independently hydrogen, an aliphatic hydrocarbon group, an alicyclic hydrocarbon group, an aryl group, an alkylaryl group, or a heterocyclic group, excluding R₅′ and R₆′ being simultaneous hydrogens. The aliphatic hydrocarbon group, the alicyclic hydrocarbon group, the aryl group, the alkylaryl group or the heterocyclic group can be substituted with at least one hydroxyl group.

The amounts of Formula (I) and Formula (II) can be varied when the composition comprises the combination of Formula (I) and Formula (II). The mole percentages of Formula (I) to Formula (II) can be varied from 0.1 mole % to 99.9 mole %. In one non-limiting embodiment, the molar ratio of Formula (I) to Formula (II) can be 1:99 to 99:1. In another non-limiting embodiment, the molar ratio of Formula (I) to Formula (II) can be 20:80 to 80:20. In yet another non-limiting embodiment, the molar ratio of Formula (I) to Formula (II) 40:60 to 60:40.

In another non-limiting embodiment, the composition for treating the non-keratinous fibers can be represented by formulations selected from the group consisting of Formula (III), Formula (IV), Formula (V), and combinations thereof.

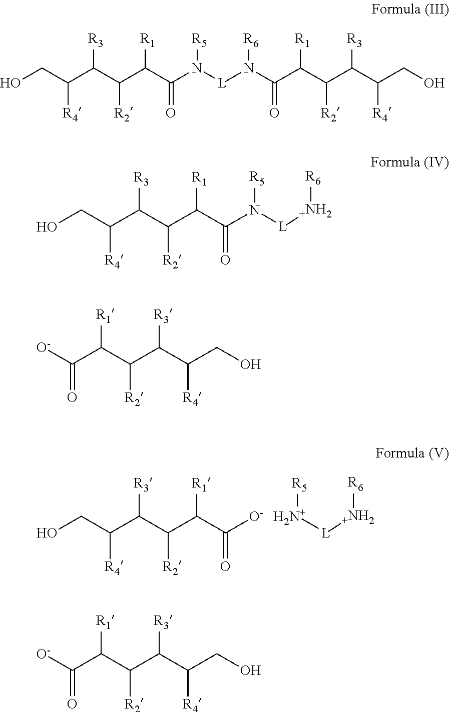

wherein R₁′-R₄′ are independently hydrogen, a hydrocarbon radical having 1 to about 10 carbon atoms, a hydroxyl group, an amino group, a sulfhydryl group, an aryl group, or a halogen; and R₅′-R₆′ are independently hydrogen, an aliphatic hydrocarbon group, an alicyclic hydrocarbon group, an aryl group, an alkylaryl group, or a heterocyclic group. L is a linker group and can be an aliphatic hydrocarbon group, an alicyclic hydrocarbon group, an aryl group, an alkylaryl group, or a heterocyclic group. The aliphatic hydrocarbon group, the alicyclic hydrocarbon group, the aryl group, the alkylaryl group or the heterocyclic group can be further substituted by other functional groups containing oxygen, sulfur, nitrogen, and halogen.
The molar ratios of Formula (III)+Formula (IV) to Formula (V) can be varied when the treating composition comprises Formulas (III), (IV) and (V). In one non-limiting embodiment, the molar ratio of (Formula (III)+Formula (IV)) to Formula (V) can be 1:99 to 99:1. In another non-limiting embodiment, the molar ratio of (Formula (III)+Formula (IV)) to Formula (V) can be 20:80 to 80:20. In yet another non-limiting embodiment, the molar ratio of (Formula (III)+Formula (IV)) to Formula (V) can be 40:60 to 60:40.

The composition of Formula (I), and/or Formulation (II) can comprise a reaction product of at least one lactone compound and at least one amino alcohol compound. The amino alcohol compound can comprise one, two, three, or more hydroxyl groups.

In one non-limiting embodiment, the amino alcohol compound can be represented by Formula (VI):

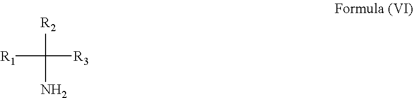

wherein R₁ and R₂ each independently represents an aliphatic hydrocarbon group, an alicyclic hydrocarbon group, an aryl group, or a heterocyclic group, where these groups are substituted with at least one hydroxyl group; and R₃ is hydrogen or an alkyl group having 1 to about 12 carbon atoms.

The aliphatic hydrocarbon group used herein can include saturated or unsaturated, liner or branched, substituted or unsubstituted aliphatic hydrocarbon groups. Examples of the aliphatic hydrocarbon groups can include, but are not limited to, a straight or branched alkyl group having to about 12 carbon atoms, such as a methyl group, an ethyl group, a propyl group, an isopropyl group, a butyl group, an isobutyl group, a sec-butyl group, a t-butyl group, a pentyl group, a hexyl group, an octyl group, and a decyl group; an alkenyl group having 1 to 12 carbon atoms, such as a vinyl group, an allyl group, a 1-propenyl group, an isopropenyl group, and a 2-butenyl group; and an alkynyl group having 1 to 12 carbon atoms, such as a 2-propynyl group, and a 2-butynyl group.

The alicyclic hydrocarbon group used herein can include saturated or unsaturated, substituted or unsubstituted alicyclic hydrocarbon groups. Examples of the alicyclic groups can include, but are not limited to, a cycloalkyl group having about 3 to about 10 carbon atoms, such as a cyclobutyl group, a cyclopentyl group, a cyclohexyl group, a cyclooctyl group; and a cycloalkenyl group having about 3 to about 10 carbon atoms, such as a cyclopentenyl group, and a cyclohexenyl group.

The aryl group used herein can comprise about 6 to about 14 carbon atoms, such as a phenyl group, and a naphthyl group.

The heterocyclic group used herein can include those containing at least one heteroatom selected from the group consisting of a nitrogen atom, an oxygen atom, and a sulfur atom. The heterocyclic group can be an aromatic heterocyclic group, a non-aromatic heterocyclic group, or a compound heterocyclic group.

A heterocyclic ring of the above-mentioned heterocyclic group can include a nitrogen-containing heterocyclic ring such as pyrroline, pyrrole, piperidine, piperazine, pyridine, pyrimidine, pyridazine, triazole, and quinoline; an oxygen-containing heterocyclic ring such as tetrahydrofuran, furan, and pyran; a sulfur-containing heterocyclic ring such as tetrahydrothiophene, and thiophene; and a heterocyclic ring containing at least two heteroatoms selected from the group consisting of a nitrogen atom, an oxygen atom, and a sulfur atom, such as thiazoline, thiazolidine, thiazole, thiazine, and morpholine.

In another non-limiting embodiment, the amino alcohol compound can be represented by Formula (VII):

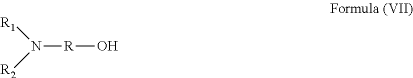

where R₁ and R₂ are independently H, an alkyl group having 1 to about 20 carbon atoms, or an alkyl group having 1 to about 20 carbon atoms substituted with at least one hydroxyl group; and R is an alkyl or alkenyl having about 2 to about 16 carbon atoms.

In yet another non-limiting embodiment, the amino alcohol compound can be represented by Formula (VIII):

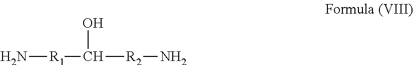

where R₁ and R₂ are an alkyl group having 1 to about 20 carbon atoms, or an alkyl group having 1 to about 20 carbon atoms substituted with at least one hydroxyl group.

Examples of the amino alcohol compound can include, but are not limited to, ethanolamine, 2-hydroxyethylhydrazine, 2-methoxyethylamine, 3-amino-1-propanol, amino-2-propanol, DL-alaninol, 3-amino-1,2-propaediol, serinol, 1,3-diamino-2-propanol, 1-amino-2-methyl-2-propanol, 2-(ethylamino)ethanol, 2-aniino-1-butanol, 2-amino-2-methyl-1-propanol, 3-methylamino-1-propanol, 4-amino-1-butanol, 2-(2-aminoethoxy)ethanol, 3-methylamino-1,2-propanediol, diethanolamine, tris(hydroxymethyl)aminomethane, N-(2-hydroxyethyl)ethylenediamine, meso-1,4-diamino-2,3-butanediol, 2-aminocyclopentanol, 2-(isopropylamino)ethanol, 2-(propylamino)ethanol, 2-amino-3-methyl-1-butanol, 5-amino-1-pentanol, 2-(3-aminopropylamino)ethanol, 1-amino-1-cyclopentanemethanol, 4-aminocyclohexanol, 2-(butylamino)ethanol, 6-amino-1-hexanol, DL-2-amino-1-hexanol, leucinol, N,N′-bis(2-hydroxyethyl)ethylenediamine, 2-aminobenzyl alcohol, 3-aminolbenzyl alcohol, 4-aminobenzyl alcohol, 2-amino-4-methoxyphenol, 3,4-dihydroxybenzylamine, 3,5-dihydroxybenzylamine, 1-aminomethyl-1-cyclohexanol, 2-aminomethyl-1-cyclohexanol, N-Bocethanolamine, 5-amino-2,2-dimethylpentanol, 2-amino-1-phenylethanol, 2-amino-3-methylbenzyl alcohol, 2-amino-5-methylbenzyl alcohol, 2-aminophenylethyl alcohol, 3-amino-2-methylbenzyi alcohol, 3-amino-4-methylbenzyl alcohol, 4-(1-hydroxyethyl)aniline, 4-aminophenethyl alcohol, N-(2-hydroxyethyl)aniline, 3-hydroxy-4-methoxybeiizyiamine, 3-hydroxytyramine, 6-hydroxydopamine, 4-(Z-amino)-1-butanol, 5-(Z-amino)-1-pentanol, 4-(Zamino) cyclohexanol, 6-(Z-amino)-1-hexanoi, 3-(Boc-amino)-1-propanol, N-Boc-serinol, 2-benzylaminoethanol, 4-(Boc-araino)-butanol, 2-(aminomethyl)-2-(hydroxyniethyl)-1,3-propanediol, and 2-(2-aminoethyl)-2-(hydroxymethyl)-1,3-propanediol.

The composition of Formula (III), or Formula (IV) or Formula (V) or the combinations can comprise a reaction product of at least one lactone compound and at least one alkyl diamine compound.

The alkyl diamine compound can contain about 2 to about 12 carbon atoms. In one non-limiting embodiment, the alkyl diamine compound can contain about 2 to about 6 carbon atoms. Examples of the alkyl diamine compound can include, but are not limited to, ethylenediamine, 1,3-diaminopropane, 1,4-diaminobutane, 1,5-diaminopentane, hexamethylene diamine, 1,7-diaminohepatane, 1,8-diaminooctane, 1,9-nonanediamine, 1, 10-diaminodecane, and dodecanethylenediamine. In one non-limiting embodiment, the alkyl diamine is ethylenediamine. In another non-limiting embodiment, the alkyl diamine is 1,3-diaminopropane.

The lactone compound of the present disclosure can include, but is not limited to, a cyclic ester compound comprising a heterocyclic ring and the heteroatom on the heterocyclic ring is oxygen, which can be represented by Formula (IX):

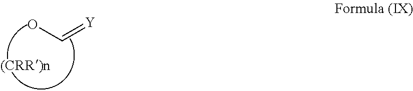

wherein R and R′ are independently H and a hydrocarbon radical containing from 1 to about 40 carbon atoms that can be saturated or unsaturated, linear or branched, substituted or unsubstituted. The hydrocarbon radicals can comprise hydroxyl groups, amino groups, sulfhydryl groups, aryl groups and halogens. n is an integer of 1 to about 10. Y is oxygen or sulfur. The heterocyclic ring can be saturated or unsaturated.

The lactone compound can comprise 3 to 8 membered rings (including the oxygen on the heterocyclic ring and the carbonyl carbon). Examples of such lactone compounds can include but are not limited to α-lactones (3-membered ring alpha-lactones), ß-lactones (4-membered ring beta-lactones), γ-lactones (5-membered ring gamma-lactones), δ-lactones (6-membered ring delta-lactones) and ε-lactones (8-membered ring epsilon-lactones).

In one non-limiting embodiment, the lactone compound can be a δ-lactone. In one non-limiting embodiment, the δ-lactone can be represented by Formula (X):

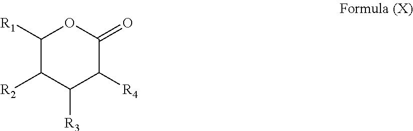

wherein R₁-R₄ are independently H, a hydrocarbon radical having 1 to about 10 carbon atoms, a hydroxyl group, an amino group, a sulfhydryl group, an aryl group, or a halogen.

In one non-limiting embodiment, R₁-R₄ are independently a hydrocarbon radical being linear or branched, saturated or unsaturated, or substituted or unsubstituted.

Examples of the δ-lactone compounds can include, but are not limited to, meadowfoam δ-lactone, δ-octalactone, δ-decalactone, δ-nonalactone, undecanoic δ-lactone, δ-dodecalactone, massoia lactone (or 5-pentylpent-2-en-5-olide), jasmine lactone (or Z-2-pentenylpentan-5-olide), 6-pentyl-alpha-pyrone (or 5-pentylpenta-2,4-dien-5-olide), δ-valerolactone, galactonolactone, glucono δ-lactone, hexadecanolactonr, and mevalonolactone.

According to the present disclosure, the lactone compound, the alkyl diamine compound or amino alcohol compound, and a solvent can be mixed together at room temperature (˜23° C.) to form a mixture. The mixture can be heated to about 30° C. to about 100° C. for at least 30 minutes to form a reaction product of the present disclosure. In one non-limiting embodiment, the mixture can be heated to about 40° C. to about 80° C. for at least 60 minutes. In another non-limiting embodiment, the mixture can be heated to about 50° C. to about 75° C. for at least 120 minutes. In yet another non-limiting embodiment, the mixture can be heated to about 55° C. to about 65° C. for at least 150 minutes.

The solvent can be water; methanol; acetone; benzene; other; alcohols and/or glycols, including, but not limited to, ethanol, isopropanol (IPA), tert-butyl alcohol (TBA), glycol, ethylene glycol, propylene glycol, diethylene glycol, and dipropylene glycol; and mixtures thereof. In one non-limiting embodiment, the solvent is water. In another non-limiting embodiment, the solvent is methanol. In yet another embodiment, the solvent is a mixture of water with methanol, ethanol, or isopropanol.

The appropriate amounts of the lactone compound and the alkyl diamine or amino alcohol compound can be determined by a skilled artisan. In one non-limiting embodiment, the molar ratio of the lactone compound to the alkyl diamine compound or amino alcohol compound ranges from about 10:1 to about 1:10. In another non-limiting embodiment, the molar ratio of the lactone compound to the alkyl diamine compound or amino alcohol compound ranges from about 8:1 to about 1:8. In yet another non-limiting embodiment, the molar ratio of the lactone compound to the alkyl diamine compound or amino alcohol compound ranges from about 5:1 to about 1:5. In yet another non-limiting embodiment, the molar ratio of the lactone compound to the alkyl diamine compound or amino alcohol compound ranges from about 2:1 to about 1:2.

Further, the composition for treating the non-keratinous fibers according to the present disclosure can also comprise a dispersing medium selected from the group consisting of water, solvent, and any combinations thereof. In one non-limiting embodiment, the dispersing medium is water. In another non-limiting embodiment, the dispersing medium can be a combination of water and the solvent. The solvent can be selected from the group consisting of C₁ to C₄ mono-hydric alcohols, C₁ to C₁₂ polyhydric alcohols such as C₂ to C₆ alkylene glycols and C₂ to C₁₂ polyalkylene glycols, C₂ to C₆ alkylene carbonates, and mixtures thereof. Examples of suitable solvent include, but are not limited to, ethanol, propanol, isopropanaol, n-butanol, ethylene glycol, propylene glycol, dipropylene glycol, propylene carbonate, butyl carbitol, phenylethyl alcohol, 2-methyl 1,3-propanediol, hexylene glycol, glycerol, polyethylene glycol, 1,2-hexanediol, 1,2-pentanediol, 1,2-butanediol, 1,4-cyclohexanediol, pinacol, 1,5-hexanediol, 1,6-hexanediol, 2,4-dimethyl-2,4-pentanediol, 2,2,4-trimethyl-1,3-pentanediol, 2-ethyl-1,3-hexanediol, phenoxyethanol, and mixtures thereof.

Further, the dispersing medium can be present in an amount ranging from about 50 wt. % to about 99.5 wt. %, from about 80 wt. % to about 99 wt. %, from about 75 wt. % to about 80 wt. % of the total composition. When the dispersing medium is comprised of water and at least one of the solvents, the water comprises greater than about 50 wt. %, or greater than about 10 wt. % of the composition; and the balance of the dispersing medium comprises the solvent.

The composition of the present disclosure when used for treating the non-keratinous fibers, and/or textile materials and/or other textile articles derived therefrom improves their robust performance and concurrently maintains and/or improves the appearance or look such as color, shine and shape, and natural feel even after prolonged use.

The composition of the present disclosure can optionally comprise at least one adjunct material. These adjunct materials can be added to provide one or more additional benefits or properties to the non-keratinous fibers, and/or textile materials and/or other textile articles derived therefrom. These additional benefits can include, but are not limited, fabric softening, fabric lubrication, fabric relaxation, durable press, wrinkle resistance, wrinkle reduction, ease of ironing, fabric smoothing, anti-felting, crispness, anti-shrinkage, fabric elasticity, static reduction, water absorbency or repellency, stain repellency, refreshing, anti-microbial, odor resistance, and any combinations thereof. The adjunct materials which can be added to composition of the present disclosure can include, but are not limited to, pH adjusters, surfactants, emulsifiers, detergents, rheology modifiers, thickening agents, antioxidants, radical scavengers, chelants, antifoaming agents, conditioning agents, antistatic agent, antimicrobials or preservatives, dyes or colorants, viscosity control agents, pearlizing and opacifying agents, chlorine scavenger, brighteners, perfumes, and mixtures thereof.

The pH of the present composition is maintained in the range of from about 2 to about 6, from about 3 to about 5, or from about 3 to about 4. The pH is typically maintained by using a suitable buffer system. The buffer system useful for the composition of the present disclosure can be any combination of an acid and a base. In one non-limiting embodiment, the buffer system comprises an inorganic and/or an organic acid and/or a salt thereof to provide the composition with a pH value from about 2 to about 6 at 25° C.

In one aspect of the buffering system, the inorganic acid is selected from the group consisting of hydrogen chloride (HCl), sulfuric acid (H₂SO₄), nitric acid (HNO₃), phosphoric acid (H₃PO₄), and combinations thereof.

In another aspect of the buffering system, the organic acid is selected from the group consisting of an alpha-hydroxy acid, a polycarboxylic acid, and combinations thereof. Accordingly, the organic acid has an acidic functional group having a pKa of about 45 or less. In one non-limiting embodiment, the organic acid has a second acidic functional group having a pKa of about 6 or less.

The organic acid can have a molecular weight less than about 500 grams per mole (g/mol). For example, but not by way of limitation, the molecular weight of the organic acid can be from about 90 g/mol to about 400 g/mol, or from about 100 g/mol to about 300 g/mol, or from about 130 g/mol to about 250 g/mol, or from about 150 g/mol to about 200, or about 190 g/mol. In another aspect, the organic acid can be soluble in water in an amount greater than about 0.2 moles per liter at 25° C. For example, but not by way of limitation, the water solubility of the organic acid may be about 0.3 mol/L or more, or about 0.4 mol/L or more, or about 0.5 mol/L or more.

Examples of the organic acids can include, but are not limited to, lactic acid, citric acid, tartaric acid, gluconolactive acid, pimelic acid, glyoxylic acid, aconitic acid, ethylenediaminetetraacetic acid, L-glutamic acid, malic acid, malonic acid, and combinations thereof. Examples of the salt of such an inorganic acid and an organic acid can include its alkali metal salts such as the sodium salt and the potassium salt; its ammonium salt; and its alkanolamine salts such as the triethanolamine salt.

The present composition can also comprise surfactants.

The at least one surfactant can be selected from the group consisting of a nonionic surfactant, an anionic surfactant, an amphoteric surfactant, a zwitterionic surfactant, and combinations thereof. Anionic surfactants which are suitable for use herein can include the water-soluble salts. The water-soluble salts can be alkali metal and ammonium salts of organic sulfuric reaction products having an alkyl group containing from about 10 to about 20 carbon atoms and a sulfonic acid or sulfuric acid ester group. (Included in the term “alkyl” is the alkyl portion of acyl groups).

Examples of this group of synthetic surfactants can include, but are not limited to, (a) the sodium, potassium and ammonium alkyl sulfates, especially those obtained by sulfating the higher alcohols (C₈-C₁₈ carbon atoms) such as those produced by reducing the glycerides of tallow or coconut oil; (b) the sodium, potassium and ammonium alkyl polyethoxylate sulfates, particularly those in which the alkyl group contains from about 10 to about 22 carbon atoms, or from about 12 to about 18 carbon atoms, and wherein the polyethoxylate chain contains from 1 to about 15, or from 1 to about 6 ethoxylate moieties; and (c) the sodium and potassium alkylbenzene sulfonates in which the alkyl group contains from about 9 to about 15 carbon atoms, in straight chain or branched chain configuration, e.g., those of the type described in U.S. Pat. Nos. 2,220,099 and 2,477,383, which are incorporated herein by reference in their entirety.

The sulphate or sulphonate surfactants can be selected from C₁₁₋₁₈ alkyl benzene sulphonates (LAS); C₈-C₂₀ primary, branched-chain and random alkyl sulphates (AS); C₁₀-C₁₈ secondary (2,3) alkyl sulphates; C₁₀-C₁₈ alkyl alkoxy sulphates (AExS) wherein x is from 1-30; C₁₀-C₁₈ alkyl alkoxy carboxylates comprising 1-5 ethoxy units; mid-chain branched alkyl sulphates as disclosed in U.S. Pat. Nos. 6,020,303 and 6,060,443; mid-chain branched alkyl alkoxy sulphates as disclosed in U.S. Pat. Nos. 6,008,181 and 6,020,303; modified alkylbenzene sulphonate (MLAS) as disclosed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS). All the above described patents and patent publications are hereby enclosed by reference in their entirety.

The paraffin sulphonates can be monosulphonates or disulphonates and usually are mixtures thereof, obtained by sulphonating paraffins of about 10 to about 20 carbon atoms. In one non-limiting embodiment, the sulphonates are those of C₁₂-C₁₈ carbon atoms chains. In another non-limiting embodiment, the sulphonates are C₁₄-C₁₇ carbon atoms chains. Paraffin sulphonates that have the sulphonate group(s) distributed along the paraffin chain are described in U.S. Pat. Nos. 2,503,280; 2,507,088; 3,260,744; 3,372,188 and in DE 735 096, which are hereby incorporated herein by reference in their entirety.

Alkyl glyceryl sulphonate surfactants and/or alkyl glyceryl sulphate surfactants generally used to have high monomer content (greater than about 60 wt. % by weight of the alkyl glycerol sulphonate surfactant). As used herein “oligomer” includes dimer, trimer, tetramer, and oligomers up to heptamers of alkyl glyceryl sulphonate surfactant and/or alkyl glyceryl sulphate surfactant. Minimization of the monomer content can be from 0 wt. % to about 60 wt. %, or from 0 wt. % to about 55 wt. %, from 0 wt. % to about 50 wt. %, from 0 wt. % to about 30 wt. %, by weight of the alkyl glyceryl sulphonate surfactant and/or alkyl glyceryl sulphate surfactant present.

The alkyl glyceryl sulphonate surfactant and/or alkyl glyceryl sulphate surfactant for use herein can include such surfactants having an alkyl chain length of C₁₀-C₄₀, or C₁₀-C₂₂, or C₁₂-C₁₈, or C₁₆-C₁₈. The alkyl chain can be branched or linear, wherein when present, the branches comprise a C₁-C₄ alkyl moiety, such as methyl (C₁) or ethyl (C₂). These surfactants are described in detail in WO2006/041740, which is enclosed herein by reference in its entirety. The alkyl glyceryl sulphate/sulphonate surfactant is optionally present at a level of at least 10%, or from 10% to about 40%, or from 10% to about 30% by weight of the composition.

The anionic surfactant can be dialkylsulfosuccinates. The dialkyl sulfosuccinates may be a C₆-C₁₅ linear or branched dialkyl sulfosuccinate. The alkyl moieties can be symmetrical (i.e., the same alkyl moieties) or asymmetrical (i.e., different alkyl moieties). In one non-limiting embodiment, the alkyl moiety is symmetrical. The dialkyl sulfosuccinates can be present in the liquid home care composition from about 0.5% to about 10% by weight of the composition.

Suitable nonionic surfactants in the presently disclosed and/or claimed inventive concept(s) can include alkoxylated materials, particularly addition products of ethylene oxide and/or propylene oxide with fatty alcohols, fatty acids and fatty amines.

The alkoxylated materials can have the general formula:

R—Y—(CH₂CH₂O)_{z}H

where R is a hydrophobic moiety, typically being an alkyl or alkenyl group, the group being linear or branched, primary or secondary, and having from about 8 to about 25 carbon atoms, or from about 10 to about 20 carbon atoms, or from about 10 to about 18 carbon atoms. R may also be an aromatic group, such as a phenolic group, substituted by an alkyl or alkenyl group as described above; Y is a linking group, typically being O, CO.O, or CO.N(R₁), where R₁ is H or a C₁-C₄ alkyl group; and z represents the average number of ethoxylate (EO) units present, the number being about 8 or more, or about 10 or more, from about 10 to about 30, or from about 12 to about 25, or from about 12 to about 20.

Examples of suitable nonionic surfactants can include the ethoxylates of mixed natural or synthetic alcohols in the “coco” or “tallow” chain length. In one non-limiting embodiment, the non-ionic surfactants can be condensation products of coconut fatty alcohol with about 15-20 moles of ethylene oxide and condensation products of tallow fatty alcohol with about 10-20 moles of ethylene oxide.

The ethoxylates of secondary alcohols such as 3-hexadecanol, 2-octadecanol, 4-eicosanol, and 5-eicosanol may also be used. Exemplary ethoxylated secondary alcohols can have formulae C₁₂-EO(20); C₁₄-EO(20); C₁₄-EO(25); and C₁₆-EO(30). The secondary alcohols can include Tergitol™ 15-S-3 (available from The Dow Chemical Company) and those disclosed in PCT/EP2004/003992, which is incorporated herein by reference in its entirety.

Polyol-based nonionic surfactants can also be used, examples including sucrose esters (such as sucrose monooleate), alkyl polyglucosides (such as stearyl monoglucoside and stearyl triglucoside), and alkyl polyglycerols.

The nonionic surfactants used in the presently disclosed and/or claimed inventive concept(s) can be reaction products of long-chain alcohols with several moles of ethylene oxide having a weight average molecular weight of about 300 to about 3000 Daltons. One of the nonionic surfactants of the blend is a lower hydrophillic ethoxylate. The lower hydrophillic ethoxylate is linear alcohol ethoxylate where a C₉-C₁₁ and/or C₁₂-C₁₈ linear alcohol chain is ethoxylated with an average of 1.0 to 5.0 moles of ethylene oxide per chain, or 2.0 to 4.0 moles of ethylene oxide.

The nonionic surfactant can also be a higher ethoxylate. The higher ethoxylate is a linear alcohol ethoxylate where a C₉-C₁₁ and/or C₁₂-C₁₅ linear alcohol chain is ethoxylated with at least 6.0 moles of ethylene oxide per chain, or an average of 6.0 to 20.0 moles of ethylene oxide per chain, or an average of 6.0 moles to 12.0 moles of ethylene oxide per chain. The ratio of lower ethoxylate to higher ethoxylate can be from about 1:10 to about 10:1, or from about 1:4 to 4:1.

In one non-limiting embodiment, the nonionic surfactants can be mixtures of C₉-C₁₁ linear alcohols ethoxylated with an average of 2.5, 6.0 and 8.0 moles of ethylene oxide per chain. The ratio of the 6 mole ethoxylates to 2.5 moles ethoxylates in the blend is preferably in the range of 1.5:1 to 2:1 and for 8 mole ethoxylates is in the range of 2.3:1.

Amphoteric surfactants suitable for use in the presently disclosed and/or claimed inventive concept(s) can include those that are broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group, e.g., carboxy, sulfonate, sulfate, phosphate, or phosphonate. Examples of compounds falling within this definition are sodium 3-dodecyl-aminopropionate, sodium 3-dodecylaminopropane sulfonate, sodium lauryl sarcosinate, N-alkyltaurines such as the one prepared by reacting dodecylamine with sodium isoethionate according to the teaching of U.S. Pat. No. 2,658,072, N-higher alkyl aspartic acids such as those produced according to the teaching of U.S. Pat. No. 2,438,091, and the products described in U.S. Pat. No. 2,528,378.

Zwitterionic surfactants suitable for use can include those that are broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group, e.g., carboxy, sulfonate, sulfate, phosphate, or phosphonate. Zwitterionic surfactants which are suitable include betaines, including cocoamidopropyl betaine.

The amphoteric surfactants suitable herein can also include alkylamphoacetates including lauroamphoacetate and cocoamphoacetate. Alkylamphoacetates can be comprised of monoacetates and diacetates. In some types of alkylamphoacetates, diacetates are impurities or unintended reaction products.

The composition of the present disclosure can also comprise rheology modifiers. Examples of suitable rheology modifiers can include, but are not limited to, carboxymethyl cellulose, hydroxyethyl cellulose, hydroxypropyl cellulose, hydroxypropyl methyl cellulose, hydroxypropyl guar, hydroxymethyl hydroxyethyl cellulose, and combinations thereof.

The composition of the present disclosure can also comprise other adjunct materials including, but not limited to, antimicrobial and/or preservatives such as such as 2,4,4-trichloro-2′-hydroxydiphenyl ether, commonly known as triclosan, a mixture of about 77% 5-chloro-2-methyl-4-isothiazolin-3-one and about 23% 2-methyl-4-isothiazolin-3-one, a broad spectrum preservative available from the DowDuPont Inc. as a 1.5% aqueous solution under the trade name KATHON™ CG, dimethylol-5,5-dimethylhydantoin, which is available under the tradename DANTOGUARD® from Lonza; conditioning agents such as silicones, organic conditioning oils, natural and synthetic waxes, and cationic polymers; antioxidants including but not limited to tocopherol acetates, quinines, polyphenols, and mixtures thereof, and perfume including, but not limited to, the perfume materials as described in U.S. Pat. Nos. 5,445,747, 5,500,138, and 5,531,910.

Other suitable adjunct materials can include, but are not limited to, suspending agents such as magnesium/aluminum silicate; sequestering agents such as disodium ethylenediamine tetraacetate; certain synthetic or naturally derives oils and/or fats such as triglycerides, mineral oils; wetting agents such as glycerol, polyglycerols, polyoxyethylene glycols and polyoxypropylene glycols; soil release agents such as copolymers having blocks of polyethylene terephthalate and polyoxyethylene terephthalate as disclosed in U.S. Pat. No. 3,959,230, chelants such as diethylene triamine pentaacetic acid, ethylene diamine tetra acetic acid, diethylene triamine pentamethylene phosphonic acid, citric acid and mixtures thereof, antioxidants such as tocopherol acetate, quinine, polyphenols, and mixtures thereof.

Other additional adjunct materials can also be added in the composition of the present disclosure can include, but are not limited to, dyes or colorants, pearlizing and opacifying agents, dye transfer inhibitors and dye fixatives, chlorine scavengers, electrolytes, enzymes, brighteners, and bleaching Agents. Additional examples of suitable adjunct and level of use are found in U.S. Pat. No. 6,653,275.

The adjunct materials can be added in an amount of from 0.1 wt. % to about 30 wt. %, from about 0.5 wt. % to about 10 wt. %, from about 1.0 wt. % to about 5.0 wt. % of the composition weight.

The composition according to the present disclosure can be present in any form known to those skilled in the art such as in the form of a liquid, a gel, a spray, an aerosol, a foam, a powdery solid form, a particulate form or an encapsulated a coated form.

### Treating Method(s):

The method of treating non-keratinous fibers according to the present disclosure comprises a step of applying the composition on the non-keratinous fibers. The composition can be applied directly by employing conventional methods known in the art such as dipping, spraying, soaking, and any other suitable methods known for such applications. Alternatively, the composition can be applied during laundry operation, for example, during the wash cycle, during the rise cycle, during the dry cycle, or during the pre-soaking.

In one non-limiting embodiment, the method of treating the non-keratinous fibers comprises a direct application of the composition on the non-keratinous fibers. In this embodiment, the composition can be applied by employing methods known in the art that include, but are not limited to, dipping, spraying, and soaking. The composition can be present in any suitable form know to those skilled in the art such as in the form of a liquid, a spray, an aerosol, a foam, a powdery solid form, a granular form, and encapsulate and coated forms thereof.

The treated non-keratinous fibers thus obtained can be dried thereafter. The method of drying is a key step of the treating process as this step stabilizes the deposition of the composition on the non-keratinous fibers. In one non-limiting embodiment, the treated non-keratinous fibers can be dried under ambient conditions. Subsequently, the treated non-keratinous fibers can optionally be dried using a heating source that can include, but is not limited to, automatic dryer, steam, heating iron, and heated air from a blow dryer. In the embodiment wherein, the treated non-keratinous fibers are dried under ambient condition followed by heat-treating, both the operations can be carried out simultaneously in one step, or these operations can optionally be conducted in separate steps, providing that the heat-treating step is performed after the drying under ambient conditions.

In another non-limiting embodiment, the treatment of the non-keratinous fibers can be carried out during laundry operations. In this embodiment, the composition can be added during any step of the laundry operations that can include, but is not limited to, pre-soaking cycle, wash cycle, rinse cycle, and drying cycle. The present composition can be used alone during the laundry operations. Alternatively, the composition can be combined with any of the laundering aids and added during the laundry operations.

In one non-limiting embodiment, the composition can be added during the wash cycle of laundry operation. In this embodiment, cleaning of the non-keratinous fibers as well as treatment thereof with the composition of the present disclosure can be conducted simultaneously. The composition can be added alone during the wash cycle. In this embodiment, the present composition can comprise detergent adjuvants and/or builders as one of the adjunct materials along with one or more of the other/additional adjunct materials as hereinabove described. In another embodiment, the present composition can be added along with conventional detergents during the wash cycle. Further, the present composition can be added in a washing machine or in any other container useful for hand-washing the non-keratinous fibers such as a tub, a bucket, or any other container. The treated non-keratinous fibers thus obtained can be rinsed with fresh water followed by drying under ambient conditions with optional heat-treating.

In another non-limiting embodiment, the composition can be added during the rinse cycle of laundry operation. The composition can be added alone during the rinse cycle. In this embodiment, the composition can comprise fabric softener and or the other/additional adjunct materials as hereinabove described. Alternatively, the composition can be added along with the conventional laundry aids used during the rinse cycle such as fabric softeners and fabric conditioners. Further, the treatment during the rinse cycle can be carried out either in a washing machine or in any other container useful for rinsing operation such as a tub, a bucket, or any other containers. The treated non-keratinous fibers thus obtained can be dried under ambient conditions followed with optional heat-treating.

In yet another non-limiting embodiment, the treatment of the non-keratinous fibers can be performed during a separate soak or treatment cycle before the fibers are laundered. In this embodiment, the effective amount of the composition is usually dissolved in a suitable medium, preferably water, either in a washing machine or in any other suitable container such as a washing tub or a bucket. In one embodiment, the composition can be added alone. In another embodiment, the composition can be added along with pre-wash laundering aids. Any conventional pre-wash laundry aids can be used. The non-keratinous fibers are then dipped and/or allowed to soak in the composition for a time period sufficient for the effective and uniform deposition of the composition onto the non-keratinous fibers. The treated non-keratinous fibers thus obtained can be dried directly under ambient conditions followed with optional heat-treating. Alternatively, the treated non-keratinous fibers can be rinsed with fresh water and/or washed with detergent followed by drying under ambient conditions with optional heart-treating.

In yet another non-limiting embodiment, the treatment of the non-keratinous fibers can be performed during a drying step. In this embodiment, the composition can be added alone during the drying cycle. Alternatively, the composition can be added along with any conventional laundry aids used during the drying cycle.

Following the first step of treating the non-keratinous fibers with the composition of the present disclosure, the subsequent treatment of the treated non-keratinous fibers can be repeated in a similar fashion by any or all other means described above.

Examples of the non-keratinous fibers treated with the composition of the present disclosure include, but are not limited to, natural fibers, synthetic fibers, and combinations thereof. Examples of the natural fibers include, but are not limited to, cotton fibers, silk fibers, and combinations thereof. Similarly, examples of the suitable synthetic fibers include, but are not limited to, polyester fibers, nylon fibers, polyamide fibers, polypropylene fibers, acrylic fibers, spandex fibers, and combinations thereof.

Another aspect of the present disclosure provides a method for treating textile materials and/or any other textile articles derived from the non-keratinous fibers with the composition of the present disclosure. The textile materials and/or other textile articles derived therefrom can be treated in a similar fashion by any or all other means as herein above described.

Still another aspect of the present disclosure provides a method of protecting colored/dyed non-keratinous fibers, and colored textile materials and/or any other textile articles derived therefrom from fading or wash-out, and wherein the method comprises treating the colored/dyed non-keratinous fibers with a composition represented by one or both of the Formula (I) and Formula (II).

Yet another aspect of the present disclosure provides a method of protecting colored/dyed non-keratinous fibers, and colored textile materials and/or any other textile articles derived therefrom from fading or wash-out, and wherein the method comprises treating the colored/dyed non-keratinous fibers with a composition represented by chemical formulations selected from the group consisting of Formula (III), Formula (IV), Formula (V), and combinations thereof.

The following examples illustrate the present disclosure, parts and percentages being by weight, unless otherwise indicated. Each example is provided by way of explanation of the present disclosure, not limitation of the present disclosure. In fact, it will be apparent to those skilled in the art that various modifications and variations can be made in the present disclosure without departing from the scope or spirit of the invention. For instance, features illustrated or described as part of one embodiment, can be used on another embodiment to yield a still further embodiment. Thus, it is intended that the present disclosure covers such modifications and variations as come within the scope of the appended claims and their equivalents.

### EXAMPLES

### A. Preparation of Reaction Products

### Example 1—Reaction of Gluconolactone with Ethylene Diamine in Water

3.2 g ethylene diamine (EDA), 23.9 g water and 35.6 g L-gluconic acid delta-lactone (GDL) were sequentially added into a 3-neck flask to form a mixture. Under nitrogen, the mixture was gradually heated to about 60° C. and kept for about 2.5 hours. Then, the temperature was decreased to 50° C. and the formed end product was poured into a container. Once the temperature was lowered to room temperature (˜21-23° C., the end product was obtained. Analytical results showed that the end product included N,N′-ethylenebis-D-gluconamide, N-(2aminoethyl)-D-gluconamide, and GDL.

### Example 2—Reaction of GDL with Ethanolamine in Water

6.16 g ethanolamine (EA), 15 g water and 17.9 g L-gluconic acid delta-lactone were sequentially added into a 3-neck flask to form a mixture. Under nitrogen, the mixture was gradually heated to about 60° C. and kept at that temperature for about 2.5 hours. Then, the temperature was decreased to 50° C. and the formed end product was poured into a container. Once the temperature was lowered to room temperature (˜21-23° C.), the end product was obtained.

### Example 3—Reaction of GDL with Ethylene Diamine in Methanol

2.40 g ethylenediamine, 79 g methanol and 14.26 g L-gluconic acid delta-lactone were sequentially added into a 3-neck flask to form a mixture. Under nitrogen, the mixture was gradually heated to reflux and kept at that temperature for about 2.5 hours. Then, the temperature was decreased to room temperature (˜21-23° C.). The final product was filtered and dried. The white powder product was obtained.

### Example 4—Reaction of GDL with 3-Amino-1-propanol in Water

15.0 g 3-amino-1-propanol (APA), 35.6 g L-gluconic acid delta-lactone and 50 g water were sequentially added into a 3-neck flask to form a mixture. Under nitrogen, the mixture was gradually heated to about 75° C. and kept at that temperature for about 2.5 hours. Then, the temperature was decreased to 50° C. and the formed end product was poured into a container. Once the temperature was lowered to room temperature (˜21-23° C.), the end product was obtained.

### Example 5—Reaction of GDL with 3-Amino-1-propanol in Methanol

5.0 g (0.2 moles) 3-amino-1-propanol, 200 g methanol and 35.6 g (0.2 moles) L-gluconic acid delta-lactone (GDL) were sequentially added into a 3-neck flask. The mixture was gradually heated under nitrogen to reflux at 60° C. and kept at that temperature for about 2.5 hours. The reaction was allowed to cool to ambient temperature (˜21-23° C.). The reaction mixture was filtered, and the product was dried in a ventilated oven at 60° C. to give a gluconamide as a white powder.

### Example 6—Reaction of GDL with Tris(hydroxymethyl)aminomethane in Water

50.0 g L-gluconic acid delta-lactone (GDL), 34.0 g tris(hydroxymethyl)aminomethane (THMAM) and 70.2 g water were sequentially added into a 3-neck flask to form a mixture. Under nitrogen, the mixture was gradually heated to about 75° C. and kept at that temperature for about 2.0 hours. Then, the temperature was decreased to 50° C. and the formed end product was poured into a container. The end product containing 55 wt % of solids in water was obtained.

### Example 7—Mixture of GDL with 3-Amino-1-Propanol in Water

5.8 g of gluconic acid (50 wt % in water) and 7.5 g of 3-amino-I-propanol were mixed in a beaker at room temperature (˜21-23° C.) for 1 hour.

### B. Measurement of the Reaction Products

### Sample Preparation

About 200 mg of the sample was dissolved in 1.3 g D₂O to form a solution. The sample solution was then transferred to a 5 mm NMR tube for analysis. For solid samples: About 100 mg of the sample was dissolved in 1.4 g D₂O to form a solution. The sample solution was transferred to a 5 mm NMR tube for analysis.

### NMR Measurement:

Quantitative ¹H NMR spectrum was recorded using a Varian 400 MHz NMR spectrometer using PFG-I probe. Acquisition parameters were as follows:
Temperature 297K,
Sweep width 16 ppm,
Pulse width 90°,
Number of scans 16, and
Relaxation delay 30 s.
   The spectrum was phase and baseline corrected using standard practice. The spectrum was calibrated assigning the trimethylsilyl propanoic acid (TSP) reference peak to 0.0 ppm.

For the Reaction Products of Diamine (EDA) and GDL:
Region A (I_{A})=3.50-3.40 ppm (singlet)
Region B (I_{B})=3.4-3.25 ppm (singlet)
Region C (I_{C})=3.25-3.10 ppm (triplet)

Diamide/Monoamide/Amine-Gluconic Acid Salt molar ratios were calculated as follows:

Diamide=(I_{A})/(I_{A}+I_{B}+²I_{C})

Monoamide=(2I_{C})/(I_{A}+I_{B}+2I_{C})

Amine-Gluconic Acid Salt=(I_{B})/(I_{A}+I_{B}+2I_{C})

For the Reaction Product of Amine Alcohol Compound (EA/APA) and GDL:
Region A (I_{A})=4.40-4.20 ppm (doublet)
Region B (I_{B})=4.25-4.10 ppm (doublet)

Monoamide/Amine-Gluconic Acid Salt Molar Ratios were Calculated as Follows:

Monoamide=(I_{A})/(I_{A}+I_{B})

Amine-Gluconic Acid Salt=(I_{B})/(I_{A}+I_{B}).

Table 1 lists the ¹H NMR measurement results of the reaction products of Examples 1-7.

TABLE 1

| | | | | Mole % |
|---|---|---|---|---|
| | | | | Amine- |
| | GDL/Amine | Mole % | Mole % | Gluconic |
| Sample | (Molar Ratio) | Monoamide | Diamide | Acid Salt |
| Example 1 | 2:1 | 42.0 | 56.0 | 2.0 |
| Example 2 | 1:1 | 54.0 | — | 46.0 |
| Example 3 | 1:1 | 88.0 | 10.0 | 2.0 |
| Example 4 | 1:1 | 59.0 | — | 41.0 |
| Example 5 | 1:1 | >99.0 | — | <1.0 |
| Example 6 | 1:1 | >99.0 | — | <1.0 |
| Example 7 | 1:1 | 7.0 | — | 93.0 |

### C. Treatment of Non-Keratinous Fibers and their Strengthening Tests

I. Treatment of Non-Keratinous Fibers with the End Products of Examples 1-7.

(i) Soaking Method:

Polyester swatches (PN-01) of size (7.5×15 cm), available from Center for Test materials BV, Vlaardingen, the Nederlands, were used. These polyester swatches were washed three times with water before treating with the End Products of examples 1-7. The End Product of Example 4 was were directly diluted with water in a 200 ml closed cap glass bottle to obtain 1 wt. % aqueous solution. Similarly, 5 wt. % aqueous solution of the End Product of Example 4 was also prepared in another glass bottle. pH of both the aqueous solutions was typically maintained at 4 by using citric acid or citric acid/sodium hydroxide. 1 wt. % citric acid solution was also prepared in a separate glass bottle. Total 15 polyester swatches (PN-01) were used. These polyester swatches were grouped into 3 bundles; each of the bundle was comprised of 5 polyester swatches. These 3 bundles of the polyester swatches were then put into the three different glass bottles containing 1 1 wt. % and 5 wt. % aqueous solution of the End Product of Example 4, and 1 wt. % citric acid solution, respectively. These glass bottles were then capped and put horizontally on a roller at 80 rpm for 60 minutes. Thereafter, the aqueous solutions were poured out from these glass bottles and the treated polyester swatches thus obtained were removed from the bottles and put on absorbance tissues and were then dried overnight at temperature 23±2° C. and a humidity of 50%±2%. The treated and dried polyester swatches were then subjected to tear and tensile strengthening tests.

The polyester swatches (PN-01) were also treated with the End Products of Example 1-3, and 5-7 by soaking methods, in a manner as described above for the End Product of Example 4.

(ii) Spray Method:

The End Product of Example 4 was dissolved in water to obtain three different aqueous solutions: 1 wt. %, 5 wt. %, and 20 wt. %, respectively. The polyester swatches were placed in three different aluminum containers and then sprayed eight times individually with the aqueous solution prepared on each side of the swatches. The treated swatches were hung up on a drying frame in a controlled humidity and temperature room (50% HR, 23° C.) until completely dried.

Cotton swatches (CN-11) were also treated with the End Product of Example 4 by spray method, in a manner described above for treating the polyester swatches.

### II. Tear Strength Measurement:

(i) By using Textile Analyzer:

The Tear Strength of the polyester and cotton swatches treated by the soaking and spray methods as hereinabove described was measured using a Textile Analyzer (TA-XT2i) commercially available from Stable Micro System in UK was used for tear strength measurement. The dried and treated polyester swatch was partly cut in two halves. These partly cut two halves were then fixed into two vertical parallel grips, which moved up and down. The under grip was fixed. The upper grip can be moved up and down. A program was set up so that the upper grip moved up with a speed of 1 millimetre per second until reached a tension of 1 gram, and then hold there for 10 seconds, then the upper grips moved up again with a speed of 5 millimeter per second until reached 100-millimeter distance and the tearing force was recorded. The upper grip moved back to start position with a speed of 5 millimeter per second. Exponent software from the Textile Analyzer was used to calculate the energy required to tear 100-millimeter swatch, and that energy was called tearing energy resistance expressed in N·cm (Newton times centimeter). The higher the energy applied to tear 100-millimeter swatch, the stronger the swatch becomes. Similarly, the tear strength of the both, untreated and treated cotton swatches was also measured.

The Tear Strength results were shown in Table 2, Table 3, Table 4, and Table 5.

Table 2 and Table 3 showed Tear Energy Resistance in N·cm (Newton times centimeter) of the polyester and cotton swatches treated with End Products of example-1 by the soaking method. 3)

TABLE 2
Tear Energy Resistance in N · cm (Newton times
centimeter) of the Polyester swatches treated with
the End Product of example 4 by soaking method.

| | Tear energy | Standard |
|---|---|---|
| | resistance | Deviation |
| Sample | (N · cm) | (n = 5 swatches) |
| PN-01 (untreated) | 144.5 | 3.2 |
| PN-01 treated 1 wt. % active | 139.9 | 2.0 |
| Citric Acid. | | |
| PN-01 treated with 1 wt. % End | 147.7 | 4.8 |
| Products of example 4. | | |
| PN-01 treated with 5 wt. % End | 161.4 | 7.0 |
| Products of example 4. | | |

TABLE 3
Tear Energy Resistance in N · cm (Newton
times centimeter) of cotton swatches treated
with the End Product of example 4 by soaking method.

| | Tear energy | Standard |
|---|---|---|
| | resistance | Deviation |
| Sample | (N · cm) | (n = 5 swatches) |
| CN-11 (untreated) | 62.6 | 0.3 |
| CN-11 treated with 1 wt. % End | 64.7 | 0.8 |
| Products of example 4. | | |

From the data provided in Table 2, it is evident that the polyester swatches treated with 1 wt. % and/or 5 wt. % aqueous solution of the End Product of Example 4 by soaking method showed higher tear energy resistance as compared to the untreated polyester swatch and the polyester swatch treated only with 1 wt. % aqueous solution of citric acid. Tear strength of the polyester swatches treated with 1 wt. % aqueous solution of citric acid was reduced. However, the tear strength increased when the polyester swatches were treated with 1 wt. % aqueous solution of the End Product of Example 4. The tear strength further improved significantly in case of treating the polyester swatches with 5 wt. % aqueous solution of the End Product of Example 4.

From the data provided in Table 3, it is further evident that the cotton swathes treated with 1 wt. % End Products of example 4 also showed higher tear energy resistance as compared to the untreated cotton swatch.

Table 4 and 5 list the Tear Energy Resistance in N·cm (Newton times centimeter) of polyester swatches and cotton swatches treated with the End Product of example 4 by spray method.

TABLE 4
Tear Energy Resistance in N · cm (Newton times
centimeter) of polyester swatches (PN-01) treated
with the End Product of example 4 by spray method.

| | Tear energy | standard |
|---|---|---|
| | resistance | deviation |
| Sample | (N · cm) | (n = 5 swatches) |
| PN-01 treated 0 wt. % End Product | 172.9 | 3.4 |
| of examples 4 | | |
| PN-01 treated 1 wt. % End Product | 181.9 | 3.4 |
| of example 4 | | |
| PN-01 treated 5 wt. % End Product | 190.1 | 5.5 |
| of example 4 | | |
| PN-01 treated 20 wt. % End | 188.9 | 10.8 |
| Product of example 4 | | |

TABLE 5
Tear Energy Resistance in N · cm (Newton times
centimeter) of cotton swatches (CN-11) treated
with the End Product of example 4 by spray method.

| | Tear energy | standard |
|---|---|---|
| | resistance | deviation |
| Sample | (N · cm) | (n = 5 swatches) |
| CN-11 treated 0 wt. % End Products | 42.4 | 1.1 |
| of example 4 | | |
| CN-11 treated 1 wt. % End Products | 43.0 | 1.6 |
| of example 4 | | |
| CN-11 treated 5 wt. % End Products | 44.3 | 1.2 |
| of example 4 | | |
| CN-11 treated 20 wt. % End | 45.0 | 1.8 |
| Products of example 4 | | |

From the data provided in Table 4, it is evident that the Tear Energy Resistance of the polyester swatches (PN-01) treated with the 1 wt. %, 5 wt. % and 20 wt. % aqueous solution of the End Product of example 4 by spray method also showed significant enhancement in the tear energy resistance as compared to the untreated polyester swatch. Similarly, the cotton swatches (CN-11) treated with the 1 wt. %, 5 wt. % and 20 wt. % aqueous solution of the End Product of example 4 also showed higher tear energy resistance as compared to the untreated cotton swatch.

III. Tensile Strength Measurement using Cyclic Fatigue Measurement:

### Sample Preparation:

Cotton swatches (CN-11) size (7.5×15 cm), available from Center for Test materials BV, Vlaardingen, the Nederlands were used for cyclic fatigue tensile strength. These cotton swatches (CN-11) were washed three times with water before treating with the End Products of examples 1-7. 1 wt. % aqueous solutions of the End Product of example 4 was prepared. The pH of the aqueous solutions was adjusted to 4.0 using citric acid or citric acid/sodium hydroxide. The cotton swatches were then soaked in the 1 wt. % aqueous solution prepared for 24 hours without agitation. The treated cotton swatches thus obtained were then taken out and dried at a controlled temperature of 23±2° C. and a controlled room humidity of 50% 2%. The treated and dried cotton swatches were disconnected along the length to get single fibers. Each fiber was then crimped using PVC-lined brass crimps provided from Dia-Stron Limited (Andover, UK). The space between two crimps was set at 30 mm. After crimping, the crimped sample was then lay carefully avoiding any twisting in the fiber on a sample cassette containing 50 fibers. The sample cassette was then placed in a controlled environment chamber for at least 2 hours to allow the fibers equilibrated at constant temperature and humidity (23° C.-50% HR).

### Tensile Strength Analysis Using Cyclic Fatigue Method:

A cyclic Tester (CYC801) was used for cyclic fatigue tensile measurement, along with an automatic fiber sample loading module ASL1500 (loaded with 50 fibers). The instrument and its accessories were available from Dia-Stron Limited, Andover, UK. 50. The treated cotton fibers were automatically loaded for repeating constant strain measurement with a speed of 40 mm per minute, lower trigger load of 10 gmf, break Threshold of 50 gmf. The constant strain of 12% was applied to the cotton fibres. The tensile test was ended when all the cotton fibres were broken or reached the maximum cycle of 100 000. The cycle numbers of breaking each cotton fibre was recorded. The survival probabilities of the treated and untreated (control) cotton fibres versus cycle numbers were obtained using UvWin OC Application Software (available from Dia-Stron Limited UK), which was based on Weibull analysis. The Weibull α-parameter or characteristic life time or Scale was the cycle numbers for breaking 63.2% of textile fibres. The higher the cycle numbers for breaking, the stronger the textile fibres becomes.

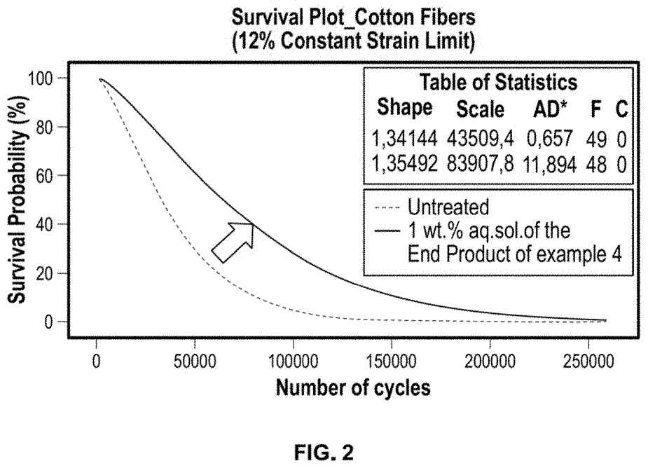

Table 6 lists the cyclic numbers of breaking for the cotton swatches (CN-11) treated with the 1 wt. % aqueous solution of the End Product of Example 4. From the data provided in Table-6, it is evident that the cotton swatches treated with the 1 wt. % aqueous solution of the End Product of example 4 showed higher cycle numbers for breaking as compared to the untreated cotton swatches at the constant strain of 12%. Further, the survival probabilities of the treated and untreated (control) cotton swatches versus cycle numbers were also shown in FIG. 2. From the provided FIG. 2 it is clear that the cotton swatches treated with the 1 wt. % aqueous solution of the End Product of example 4 (solid red line) has higher scale value than the untreated cotton swatch (dashed blue line). This clearly showed that the treated cotton swatches required more number of cycle to break than untreated cotton swatches, and the treated cotton swatches became stronger after the treatment.

TABLE 6
Cycle numbers for breaking for the cotton swatches (CN-11)

| | | Cycle numbers for |
|---|---|---|
| Sample | Constant strain | breaking |
| Cotton (CN-11) untreated | 12% | 43509 |
| Cotton (CN-11) treated with end | 12% | 83908 |
| products of examples 1-5, and 7-8 | | |

IV. Test Method for Strengthening of Wool and Polyester Fibers with Rinse Cycle:

Five swatches where washed with a Tergotometer in a 1 L mixture of 300 ppm hard water (3 Ca2+/1 Mg+) and 4 g of a stain remover “Oxiclean Versatile stain remover” containing hydrogen percarbonate. After 30 minutes at 60° C. the swatches where rinsed under running tap water for one minute for each swatch. The next step was to rinse the swatches in a mixture of 20 mg dissolved in a 1 L solution of 300 ppm hard water (3 Ca2+/1 Mg+). The swatches where mixed for 30 minutes at 60° C., after 30 minutes the swatches where gently squeezed to remove excess water and airline dried overnight. This process is repeated for five times for polyester samples and wool is done with one cycle. After all the necessary cycles where done the swatches where measured for their tear strength with help of the Texture Analyzer.

### Test Method for Measuring Fiber Strength:

Install a AT/G grip on the Texture Analyzer and make a gap between the two grips of 30 mm. Calibrate the force and distance before the measurements. Make a precut of 4 cm on the short side of the swatch precisely in the middle. When you place the swatch between the two grips make sure that the left side is in the upper grip and the right side in the lower grip. Start the test with the following values: Test speed: 5 mm/sec for Polyester & 1 mm/sec for wool, Distance: 100 mm. Start the test and use the same settings for five swatches which were treated with the same treatment. When the tests are complete let the software calculate what the force was needed for each individual fiber and calculate the total force needed to tear trough the 100 mm.

TABLE 7
Fabric Softener formulations

| | With Hydroxypropyl | |
|---|---|---|
| | Gluconamide (and) | |
| | Hydroxypropyl | |
| | Ammonium Gluconate | Blanco |
| INCI | (% w/w) | (% w/w) |
| Water | 78.9 | 88.9 |
| Dipalmitoylyethyl | 11.0 | 11.0 |
| hydroxyethylmonium methosulfate | | |
| Hydroxypropyl Gluconamide (and) | 10.0 | 0.0 |
| Hydroxypropyl Ammonium Gluconate | | |
| Propylene Glycol (and) Benzyl Alcohol | 0.1 | 0.1 |
| (and) Methylchloroisothianzolinone | | |
| (and) Methylisothiazolinone | | |
| Phosphoric acid | (pH modifier | (pH modifier |
| | between pH | between pH |
| | 3.0-4.0) | 3.0-4.0) |

TABLE 8
Tests done on single wool wash & rinse cycle

| | Total Tear | |
|---|---|---|
| | Strength | STDEV |
| Blanco (No Treatment) | 108.3 | 7.8 |
| Control (Only Oxiclean | 71.6 | 3.1 |
| Versatile stain remover) | | |
| 50 ppm hydroxypropyl | 89.9 | 3.4 |
| gluconamide (and) | | |
| hydroxypropyl | | |
| ammonium gluconate in | | |
| solution during rinse cycle | | |
| 400 ppm hydroxypropyl | 102.5 | 5.5 |
| gluconamide (and) | | |
| hydroxypropyl | | |
| ammonium gluconate in | | |
| solution during rinse cycle | | |

There is a significant improvement when hydroxypropyl gluconamide (and) hydroxypropyl ammonium gluconate is added to fabric softener in the rinse cycle. When 400 ppm hydroxypropyl gluconamide (and) hydroxypropyl ammonium gluconate solution is added during the rinse cycle you have almost the same tear strength as an untreated sample, but with a 50-ppm dose there is still a significant increase in tear strength compared to no treatment.

TABLE 9
Tests done on polyester with five wash & rinse cycles

| | Total Tear | |
|---|---|---|
| | Strength | STDEV |
| Blanco (No Treatment) | 139.8 | 4.2 |
| 0 ppm hydroxypropyl | 126.1 | 3.8 |
| gluconamide (and) | | |
| hydroxypropyl | | |
| ammonium gluconate | | |
| in solution during | | |
| rinse cycle | | |
| 100 ppm hydroxypropyl | 136.5 | 4.1 |
| gluconamide (and) | | |
| hydroxypropyl | | |
| ammonium gluconate | | |
| in solution during | | |
| rinse cycle | | |

After five wash & rinse cycles you have a small decrease in tear strength, but when 100 ppm hydroxypropyl gluconamide (and) hydroxypropyl ammonium is added to the rinse cycle you can see an increase in tear strength which is almost the same value as an untreated polyester sample.

While this invention has been described in detail with reference to certain preferred embodiments, it should be appreciated that the present invention is not limited to those precise embodiments. Rather, in view of the present disclosure, many modifications and variations would present themselves to those skilled in the art without departing from the scope and spirit of this invention.

What is claimed is:

1. A method of treating non-keratinous fibers with a composition represented by one or both of the following formulas: 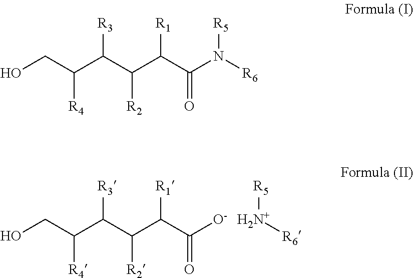
wherein R₁-R₄ are independently hydrogen, a hydrocarbon radical having 1 to about 10 carbon atoms, a hydroxyl group, an amino group, a sulfhydryl group, an aryl group, or a halogen; R₅ and R₆ are independently hydrogen, an aliphatic hydrocarbon group, an alicyclic hydrocarbon group, an aryl group, an alkylaryl group or a heterocyclic group; R₁′-R₄′ are independently hydrogen, a hydrocarbon radical having 1 to about 10 carbon atoms, a hydroxyl group, an amino group, a sulfhydryl group, an aryl group, or a halogen; R₅′ and R₆′ are independently hydrogen, an aliphatic hydrocarbon group, an alicyclic hydrocarbon group, an aryl group, or a heterocyclic group, excluding R₅′ and R₆′ being simultaneous hydrogens;
wherein the aliphatic hydrocarbon group, the alicyclic hydrocarbon group, the aryl group, the alkylaryl group or the heterocyclic group is substituted with at least one hydroxyl group.

2. A method of treating non-keratinous fibers with a composition represented by chemical formulations selected from the group consisting of Formula (III), Formula (IV), Formula (V), and combinations thereof: 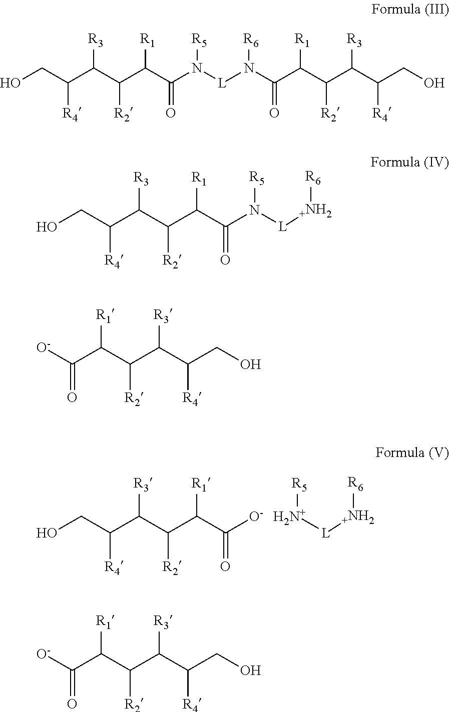
wherein R₁′-R₄′ are independently hydrogen, a hydrocarbon radical having 1 to about 10 carbon atoms, a hydroxyl group, an amino group, a sulfhydryl group, an aryl group, or a halogen; R₅′-R₆′ are independently hydrogen, an aliphatic hydrocarbon group, an alicyclic hydrocarbon group, an aryl group, an alkylaryl group, or a heterocyclic group; and L is an aliphatic hydrocarbon group, an alicyclic hydrocarbon group, an aryl group, an alkylaryl group, or a heterocyclic group.

3. The method according to claim 2, wherein the aliphatic hydrocarbon group, the alicyclic hydrocarbon group, the aryl group, the alkylaryl group, or the heterocyclic group is substituted with at least one hydroxyl group.

4. The method according to claim 1 or 2, wherein the pH value of the composition is adjusted to about 2 to about 6 by using a buffer system.

5. The method according to claim 4, wherein the buffer system comprises an acid or a salt.

6. The method of according to claim 5, wherein the acid is an organic acid.

7. The method according to claim 6, wherein the organic acid is selected from the group consisting of lactic acid, citric acid, tartaric acid, gluconolactive acid, pimelic acid, glyoxylic acid, aconitic acid, ethylenediaminetetraacetic acid, L-glutamic acid, malic acid, malonic acid, and combinations thereof.

8. The method according to claim 5, wherein the acid is an inorganic acid.

9. The method according to claim 8, wherein the inorganic acid is selected from the group consisting of hydrogen chloride (HCl), sulfuric acid (H₂SO₄), nitric acid (HNO₃), phosphoric acid (H₃PO₄), and combinations thereof.

10. The method according to claim 1, wherein the composition comprises a reaction product of at least one lactone and at least one amino alcohol compound.

11. The method according to claim 2, wherein the composition comprises a reaction product of at least one lactone compound and at least one alkyl diamine compound.

12. The method according to claim 10 or 11, wherein the lactone compound is a delta-lactone represented by the formula 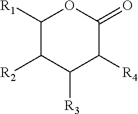
wherein R₁-R₄ are independently hydrogen, a hydroxyl group, an amino group, a sulfhydryl group, an aryl group, a halogen, or a hydrocarbon radical having 1 to about 10 carbon atoms;
and wherein the hydrocarbon radical is linear or branched, saturated or unsaturated, or substituted or unsubstituted.

13. The method according to claim 12, wherein the delta-lactone is selected from the group consisting of meadowfoam delta-lactone, delta-octalactone, delta-decalactone, delta-nonalactone, undecanoic delta-lactone, delta-dodecalactone, massoia lactone, jasmine lactone, 6-pentyl-alphapyrone, delta-valerolactone, galactonolactone. glucono delta-lactone, hexadecanolactone, and mevalonolactone.

14. The method according to claim 10, wherein the amino alcohol compound comprises 1 to 14 carbon atoms.

15. The method according to claim 14, wherein the amino alcohol compound is selected from the group consisting of ethanolamine, 2-hydroxyethylhydrazine, 2-methoxyethylamine, 3-amino-1-propanol, amino-2-propanol, DL-alaninol, 3-amino-1,2-propaediol, serinol, 1,3-diamino-2-propanol, 1-amino-2-methyl-2-propanol, 2-(ethylamino)ethanol, 2-aniino-1-butanol, 2-amino-2-methyl-1-propanol, 3-methylamino-1-propanol, 4-amino-1-butanol, 2-(2-aminoethoxy)ethanol, 3-methylamino-1,2-propanediol, diethanolamine, tris(hydroxymethyl)aminomethane, N-(2-hydroxyethyl)ethylenediamine, meso-1,4-diamino-2,3-butanediol, 2-aminocyclopentanol, 2-(isopropylamino)ethanol, 2-(propylamino)ethanol, 2-amino-3-methyl-1-butanol, 5-amino-1-pentanol, 2-(3-aminopropylamino)ethanol, 1-amino-1-cyclopentanemethanol, 4-aminocyclohexanol, 2-(butylamino)ethanol, 6-amino-1-hexanol, DL-2-amino-1-hexanol, leucinol, N,N′-bis(2-hydroxyethyl)ethylenediamine, 2-aminobenzyl alcohol, 3-aminolbenzyl alcohol, 4-aminobenzyl alcohol, 2-amino-4-methoxyphenol, 3,4-dihydroxybenzylamine, 3,5-dihydroxybenzylamine, 1-aminomethyl-1-cyclohexanol, 2-aminomethyl-1-cyclohexanol, N-Bocethanolamine, 5-amino-2,2-dimethylpentanol, 2-amino-1-phenylethanol, 2-amino-3-methylbenzyl alcohol, 2-amino-5-methylbenzyl alcohol, 2-aminophenylethyl alcohol, 3-amino-2-methylbenzyi alcohol, 3-amino-4-methylbenzyl alcohol, 4-(1-hydroxyethyl)aniline, 4-aminophenethyl alcohol, N-(2-hydroxyethyl)aniline, 3-hydroxy-4-methoxybeiizyiamine, 3-hydroxytyramine, 6-hydroxydopamine, 4-(Z-amino)-1-butanol, 5-(Z-amino)-1-pentanol, 4-(Z-amino) cyclohexanol, 6-(Z-amino)-1-hexanoi, 3-(Boc-amino)-1-propanol, N-Boc-serinol, 2-benzylaminoethanol, 4-(Boc-araino)-butanol, 2-(aminomethyl)-2-(hydroxyniethyl)-1,3-propanediol, 2-(2-aminoethyl)-2-(hydroxymethyl)-1,3-propanediol, and combinations thereof.

16. The method according to claim 11, wherein the alkyl diamine compound comprises about 2 to about 12 carbon atoms and is selected from the group consisting of ethylenediamine, 1,3-diaminopropane, 1,4-diaminobutane, pentane-1,5-diamine, hexamethylene diamine, decamethylenediamine, and combinations thereof.

17. The method according to claim 10, wherein the molar ratio of the lactone compound to the amino alcohol compound ranges from about 5:1 to about 1:5.

18. The method according to claim 11, wherein the molar ratio of the lactone compound to the alkyl diamine compound ranges from about 5:1 to about 1:5.

19. The method according to claim 1 or 2, wherein the composition further comprises at least one adjunct material selected from the group consisting of pH adjusters, surfactants, emulsifiers, detergents, rheology modifiers, thickening agents, antioxidants, radical scavengers, chelants, antifoaming agents, conditioning agents, antistatic agent, antimicrobials or preservatives, dyes or colorants, viscosity control agents, pearlizing and opacifying agents, chlorine scavenger, brighteners, perfumes, and mixtures thereof.

20. The method according to claim 19, wherein the adjunct material is present in an amount of from about 0.1 wt. % to about 30 wt. %, based on the total weight of the composition.

21. The method according to claim 1 or 2, wherein the step of treating includes direct application of the composition on the non-keratinous fibers either by dipping the non-keratinous fibers in the composition or by spraying the composition on the non-keratinous fibers.

22. The method according to claim 19, wherein the composition further comprising at least one laundering aid selected from the group consisting of detergents or soaps, stain removal agents, odor removal agents, fabric softeners, conditioning agents, dry-cleaning agents, brightening agents, enzyme pre-soak agents, pre-wash soil or stain removal agents, starches, fabric finishing agents, and sizing agents.

23. The method according to claim 19, wherein the composition is a fabric care composition.

24. The method according to claim 21, wherein the non-keratinous fibers are selected from the group consisting of cotton fibers, polyester fibers, and combinations thereof.

25. The method according to claim 24, wherein the non-keratinous fibers are colored or non-colored fibers.

26. Use of a composition represented by one or both of the following formulas for treating non-keratinous fibers: 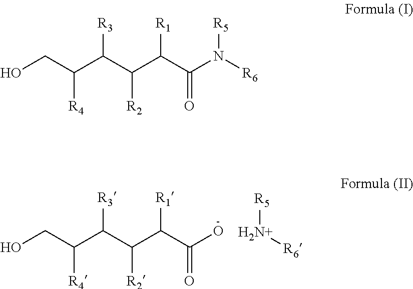
wherein R₁-R₄ are independently hydrogen, a hydrocarbon radical having 1 to about 10 carbon atoms, a hydroxyl group, an amino group, a sulfhydryl group, an aryl group, or a halogen; R₅ and R₆ are independently hydrogen, an aliphatic hydrocarbon group, an alicyclic hydrocarbon group, an aryl group, an alkylaryl group or a heterocyclic group; R₁′-R₄′ are independently hydrogen, a hydrocarbon radical having 1 to about 10 carbon atoms, a hydroxyl group, an amino group, a sulfhydryl group, an aryl group, or a halogen; R₅′ and R₆′ are independently hydrogen, an aliphatic hydrocarbon group, an alicyclic hydrocarbon group, an aryl group, or a heterocyclic group, excluding R₅′ and R₆′ being simultaneous hydrogens, wherein the aliphatic hydrocarbon group, the alicyclic hydrocarbon group, the aryl group, the alkylaryl group or the heterocyclic group is substituted with at least one hydroxyl group.

27. Use of a composition represented by chemical formulations selected from the group consisting of Formula (III), Formula (IV), Formula (V), and combinations thereof for treating non-keratinous fibers: 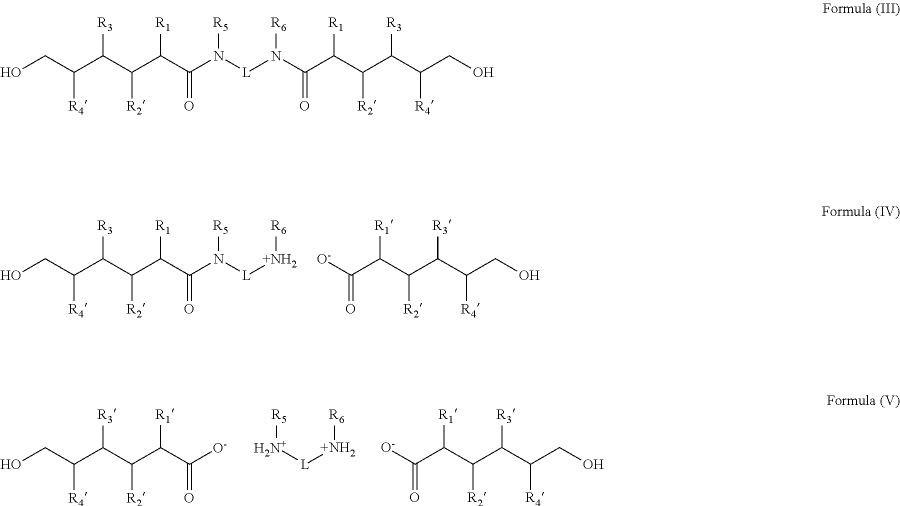
wherein R₁′-R₄′ are independently hydrogen, a hydrocarbon radical having 1 to about 10 carbon atoms, a hydroxyl group, an amino group, a sulfhydryl group, an aryl group, or a halogen; R₅′-R₆′ are independently hydrogen, an aliphatic hydrocarbon group, an alicyclic hydrocarbon group, an aryl group, an alkylaryl group, or a heterocyclic group; and L is a linker and is an aliphatic hydrocarbon group, an alicyclic hydrocarbon group, an aryl group, an alkylaryl group, or a heterocyclic group.

28. The use of the composition according to claim 27, wherein the aliphatic hydrocarbon group, the alicyclic hydrocarbon group, the aryl group, the alkylaryl group, or the heterocyclic group is substituted with at least one hydroxyl group.

29. The use of the composition according to claim 26 or 27, wherein the composition is used for improving the tear strength, tensile strength, strength from a rinse cycle of the non-keratinous fibers.

30. The use of the composition according to claim 26 or 27, wherein the composition has a pH value of about 2 to about 6.
